(19) United States
(12) Patent Application Publication
(10) Pub. No.: US 2004/0112935 A1
(43) Pub. Date: Jun. 17, 2004

(54) Integrated flex substrate metallurgical bonding

(75) Inventors: Peter J. Sinkunas, Canton, MI (US); Myron Lemecha, Dearborn, MI (US); Andrew Z. Glovatsky, Plymouth, MI (US); Zhong-You Shi, Ann Arbor, MI (US); William Zhang, Troy, MI (US); Kevin You, Farmington Hills, MI (US)

Correspondence Address: VISTEON 29074, BRINKS HOFER GILSON & LIONE, P.O. BOX 10395, CHICAGO, IL, 60611, US

(73) Assignee: VISTEON GLOBAL TECHNOLOGIES, INC.

(21) Appl. No.: 10/319,958

(22) Filed: Dec. 16, 2002

(51) Int. Cl. B23K 37/00; B23K 31/02

(52) U.S. Cl. 228/4.5; 228/6.2; 228/119

(57) ABSTRACT

An upgrade site is formed into a flatwire for upgrade or repair of the flatwire. Generally, the upgrade site comprises a substrate, a plurality of conductive elements, a solder element, a heating element, and an adhesive layer. The plurality of conductive elements are positioned on and extend along the substrate. The solder element is positioned on an exposed surface of each conductive element. The heating element is positioned adjacent the substrate and the plurality of conductive elements for heating the solder elements. The adhesive layer is positioned on the substrate for sealing the upgrade site after upgrade or repair of the flatwire.

### FIELD OF THE INVENTION

The present invention relates generally to repairing or upgrading flatwire circuits, and more particularly relates to soldering interconnects during repair or upgrade of flatwire.

### BACKGROUND OF THE INVENTION

Repairing or upgrading flatwire in the field can be a difficult process. As used herein, flatwire, flatwire circuit, and flatwire bus are used interchangeably and refer generally to flat flexible cable, also known as ribbon cable and printed flex cable. Typically, flatwire is formed using a substrate of a polymer material, which is typically of the polyester family, and a method conductive elements encapsulated therein Thus, the material of the flatwire presents a problem on how to repair damages segments of flatwire while keeping the integrity of the substrate material and preventing degradation.

Typically, to repair a flatwire section a large heating tool, such as a hot bar, is utilized to solder two flatwire segments together. In modern vehicles, the instrument panels or cockpits often provide numerous tight locations which require repair or upgrade of flatwire. Unfortunately, the above mentioned heating tools have difficulty reaching into tight locations. These heating tools will often melt the substrate material and expose the conductive elements to the environment. Furthermore, even when two flatwire segments are successfully soldered together, i.e., upgraded or repaired, sealing the conductive elements from the environment is still difficult.

Accordingly, there exists a need to provide a method of upgrading or repairing flatwire circuits that is more simple to perform, especially without degradation of the substrate, and which also seals the conductive elements of the flatwire from the environment.

### BRIEF SUMMARY OF THE INVENTION

The present invention provides an upgrade site formed into a flatwire for upgrade or repair of the flatwire. Generally, the upgrade site comprises a substrate, a plurality of conductive elements, a solder element, a heating element, and an adhesive layer. The substrate is preferably constructed of a flexible polymer, and the plurality of conductive elements are positioned on and extend along the substrate. The solder element is positioned on an exposed surface of each conductive element. The heating element is positioned adjacent the substrate and the plurality of conductive elements for heating the solder elements. Finally, the adhesive layer is positioned on the substrate for sealing the upgrade site after upgrade or repair of the flatwire.

The adhesive layer can take many shapes and preferably seals both the opposing side edges, as well as the front and rear edges, of the upgrade site. The adhesive layer may also comprise either a thermally cured adhesive for curing by the heating element or may be a pressure sensitive adhesive. The heating element may take many forms. For example, it may be integrally formed within the substrate of the flatwire. Alternately, the heating element may comprise a separate heating patch which is externally applied to the flatwire and may further include its own adhesive layer for sealing the upgrade site. Finally, the heating element may be incorporated onto the solder elements positioned on the conductive element for directly heating the solder elements without transmitting significant heat through the substrate.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 depicts a top view of a flatwire having an upgrade site constructed in accordance with the teachings of the present invention;

FIG. 2 is a cross-sectional view taken about the line 2-2 in FIG. 1;

FIG. 3 is a cross-sectional view showing a soldering process joining two flatwires having upgrade sites as depicted in FIGS. 1-2;

FIG. 4 is a top view showing the finished product of the process shown in FIG. 3;

FIG. 5 is a cross-sectional view taken about the line 5-5 in FIG. 4;

FIG. 6 depicts the finished product of a multi-layer interconnect formed by multiple flatwires having upgrade sites constructed in accordance with the present invention;

FIG. 7 is a top view of a heating patch forming a portion of the present invention;

FIG. 8 is a cross-sectional view of the heating patch taken about the line 8-8 in FIG. 7;

FIG. 9 is a cross-sectional view showing the process of joining two flatwire segments having an upgrade site, utilizing the heating patch of FIGS. 7 and 8, constructed in accordance of the teachings of the present invention;

FIG. 10 is a cross-sectional view similar to FIG. 9 showing the process of joining two flatwire segments having an upgrade site, but illustrating an alternate embodiment of the heating patch;

FIG. 11 is a top view of the finished product resulting from the process depicted in FIG. 10;

FIG. 12 is a cross-sectional view taken about the line 12-12 in FIG. 11;

FIG. 13 is a top view of a flatwire having an alternate embodiment of an upgrade site constructed in accordance with the teachings of the present invention;

FIG. 14 is a cross-sectional view taken about the line 14-14 in FIG. 13;

FIG. 14a is an enlarged view of a selected portion of FIG. 14; and

FIG. 15 is a cross-sectional view showing the finished product using the upgrade site depicted in FIGS. 13 and 14.

### DETAILED DESCRIPTION OF THE INVENTION

Flatwire busses typically extend between various electronic sites having appropriate components for controlling or forming a system. In a vehicle, such systems include an HVAC system, a navigation system, or a radio. The electronic sites can be either a flexible circuit board or a rigid circuit board. Preferably, the electronic site is flexible and is integrally formed with the flatwire bus as a single unit. When it becomes necessary to upgrade or repair the electronic site or the flatwire, the flatwire must typically be cut in a new flatwire strip or electronic site is inserted. Thus, new interconnections must be made between the conductive elements embedding within the flatwire or electronic site. Accordingly, the present invention provides an upgrade site 30 formed into a flatwire 20 for simple and expedient upgrade or repair of the flatwire 20 or related electronic site. These upgrade sites 30 may be regularly spaced along the flatwire circuit, or may be specifically placed in predetermined positions where it is pre-determined that upgrade or repair will likely occur.

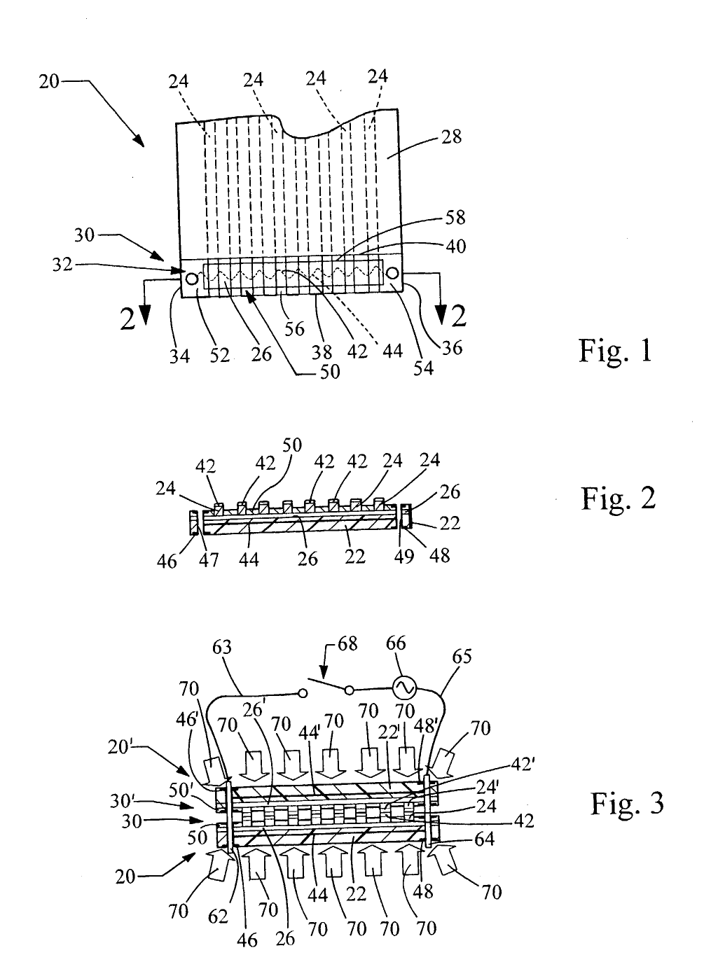

Turning now to the drawings, FIGS. 1 and 2 depict a flatwire 20 having an upgrade site 30. As best seen in FIG. 2, the flatwire 20 generally includes a number of layers including a substrate 22. A plurality of conduct elements 24 are positioned on and extend along the substrate 22. More specifically, the conductive elements 24 are adhesively attached to the substrate 22 by way of an adhesive layer 26. As shown in FIG. 1, the upper surface of the flatwire 20 includes a masking layer 28 not shown in FIG. 2 covering the conductive elements 24 and the adhesive layer 26. Typically, the substrate 22 and the masking layer 28 are constructed of a polymer material, and preferably a polyester based material such as PET, to provide the desired flexibility.

In accordance with the present invention, the flatwire 20 is provided with an upgrade site 30 which is utilized to upgrade or repair the flatwire 20. The upgrade site 30 is generally defined by a lateral strip 32 of the masking layer 28 being removed. Accordingly, this lateral strip 32 exposes the conductive elements 24, and the exposed surfaces are utilized for forming an interconnect with another flatwire segment 20. The lateral strip 32 generally extends from a first side edge 34 to a second side edge 36. The lateral strip 32 also defines a front edge 38 and a rear edge 40. Accordingly, the front edge 38 and rear edge 40, connected by the first and second side edges 34, 36, generally define a rectangular shape of the lateral strip 32, although any other shape can be utilized.

As shown in the cross-sectional view of FIG. 2, the upgrade site 30 is further provided with a solder element 42 positioned on the exposed surface of each conductive element 24. The solder element 42 may comprise a pre-plated solder, a solder paste, or a solder pre-form, as is known in the art. A heating element 44 is positioned adjacent the substrate 22 and the plurality of conductive elements 24 for heating the solder elements 42 and forming an interconnect with another flatwire 20 having an upgrade site 30. In the illustrated embodiment, the heating element 44 has been integrally formed with the substrate 22, and is imbedded therein. The heating element 44 generally comprises a highly resistive wire which is formed into the zig-zag shape shown in FIG. 1. The heating element 44 is electrically connected to first and second sleeves 46, 48. The sleeves 46, 48 are constructed of a conductive material and supply the heating element 44 with current from a power source. Additionally, the sleeves 46, 48 define alignment holes 47, 49, respectively.

Finally, the exposed area defined by the lateral strip 32 of the upgrade site 30 is provided with an adhesive layer 50. The adhesive layer 50 is designed to simultaneously seal the upgrade site 30 during the soldering process, and more particularly the upgrade or repair process. As shown in FIGS. 1 and 2, the adhesive layer 50 extends across the lateral strip 32 from the first side edge 34 to the second side edge 36, and between the conductive elements 24 which are covered with their respective solder elements 42. To entirely seal the upgrade site 30, the adhesive layer 50 preferably includes a first side strip 52 adjacent the first edge 34, a second side strip 54 adjacent the second edge 36, a front strip 56 adjacent the front edge 38, and a rear strip 58 adjacent the rear edge 40. Thus, the adhesive layer 50 leaves a portion of the conductive elements 24 and their respective solder elements 42 exposed for a soldering operation to be described below. The adhesive layer 50 may be constructed of a thermally cured adhesive such as an epoxy or urethane, but could also be made of a pressure sensitive adhesive such as an acrylic or silicone based adhesive.

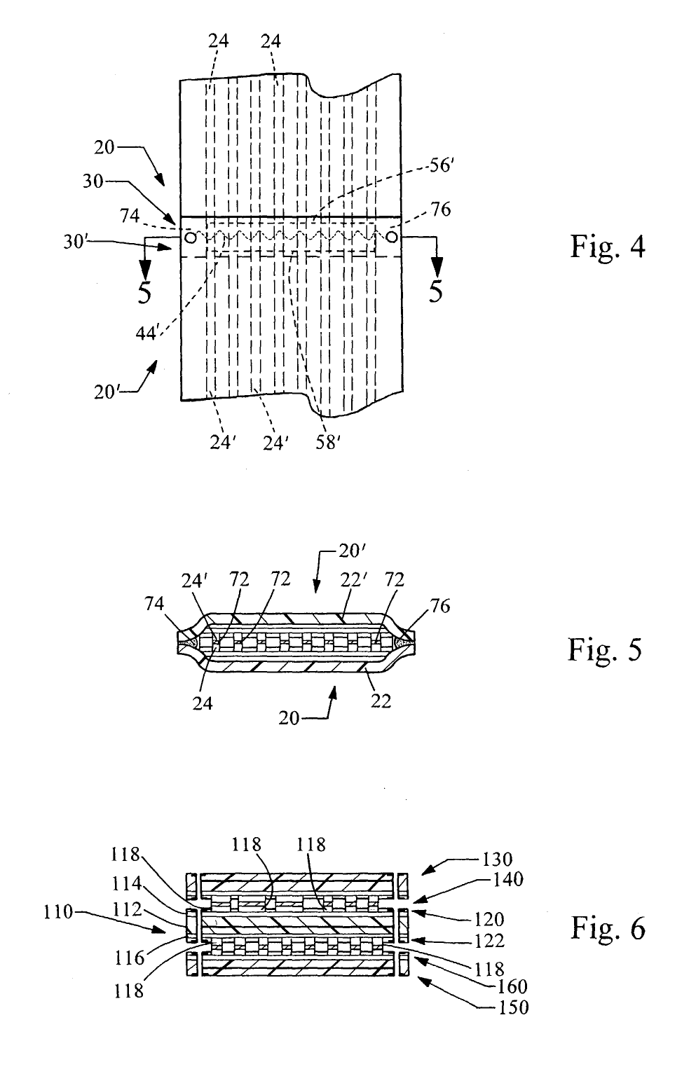

The process of utilizing the upgrade site 30 shown in FIGS. 1 and 2 will now be described with reference to FIGS. 3-5. Generally, a second flatwire 20′ is provided having an upgrade site 30′, which are in all respects identical to the flatwire 20 and upgrade site 30 illustrated in FIGS. 1 and 2. The first and second flatwire segments 20, 20′ are positioned proximate each other such that the upgrade sites 30, 30′ are facing each other and overlap, as best seen in FIG. 4. The conductive elements 24, 24′ are aligned such that their solder elements 42, 42′ are in contact. The alignment of the flatwire segments 20, 20′ is facilitated by the alignment holes 47, 49 formed by the conductive sleeves 46, 48, which also exist in the upgrade site 30′ as defined by sleeves 46′, 48′. Alignment pins 62, 64 are positioned within the alignment holes and extend through the sleeves 46, 46′, 48, 48′.

The alignment pins 62, 64 also serve to provide the heating elements 44, 44′ with electrical power. More specifically, wires 63, 65 electrically connect the pins 62, 64 with a power source 66. Accordingly, the heating elements 44, 44′ may be provided with current, which is selectively controlled by a switch 68.

When energized, the heating elements 44, 44′ output heat which spreads through the substrates 22, 22′, the conductive elements 24, 24′ and finally to the solder elements 42, 42′ for fusion of the same. When the substrate 22, 22′ are constructed of a thermoplastic material such as PET, a compressive force, generally indicated by arrow 70, is applied to control the flow of the substrates 22, 22′. The compressive force also facilitates the interconnection of the conductive elements 24, 24′ as provided by the fusion of the solder elements 42, 42′. Furthermore, the compressive force indicated by arrow 70 also serves to adhesively attach the flatwire segments 20, 20′, and more importantly completely seal the upgrade sites 30, 30′ from the environment to protect the conductive elements 24, 24′. The compressive force can be generated by a clamp or vice, or any other device which will be readily apparent to those skilled in the art.

The finished product is shown in FIGS. 4 and 5, where the fusion of solder elements 42, 42′ has formed an interconnect 72 between each of the conductive elements 24, 24′. Furthermore, the adhesive layers 50, 50′ have fused to create a seal 74, 76 at the opposing side edges of the flatwires 20, 20′. Furthermore, as shown in FIG. 4, both the front edges and rear edges of the flatwire segments 20, 20′ are sealed by the front strips 56, 56′ and rear strips 58, 58′ of the adhesive layer 50. It will be recognized that the first flatwire segment 20 could include just a front adhesive strip 56, and the second flatwire segement 20′ could just include the front adhesive strip 56′. In that case, the upgrades sites 30, 30′ would still be entirely sealed from the environment. Similarly, the flatwire segments 20, 20′ could each include just a rear adhesive strip 58, 58′ and the entire upgrade sites 30, 30′ would be sealed from the environment.

Turning now to FIG. 6, another embodiment of the invention is depicted in cross-section. As illustrated, a flatwire segment 110 may have conductive elements 118 of varying sizes on both of the opposing surfaces of the substrate 112. As in the prior embodiment, the conductive elements 118 are attached to the substrate 112 by adhesive layers 114, and 116. Accordingly, the dual-sided flatwire segment 110 will include two upgrade sites 120 and 122. Second and third flatwire segments 130 and 150 are also utilized which include upgrade sites 140, 160, respectively. The upgrade sites 140, 160 correspond with the upgrade sites 120, 122 of the dual-sided flatwire segment 110. In all other respects, the flatwire segments 110, 130, 150 are identical to the flatwire segment 20 described in the prior embodiment, and form interconnections which are sealed to the environment in the same way as previously described. Therefore, it can be seen that a multi-layer flatwire circuit can be formed utilizing flatwire busses having an upgrade site in accordance with the teachings of the present invention.

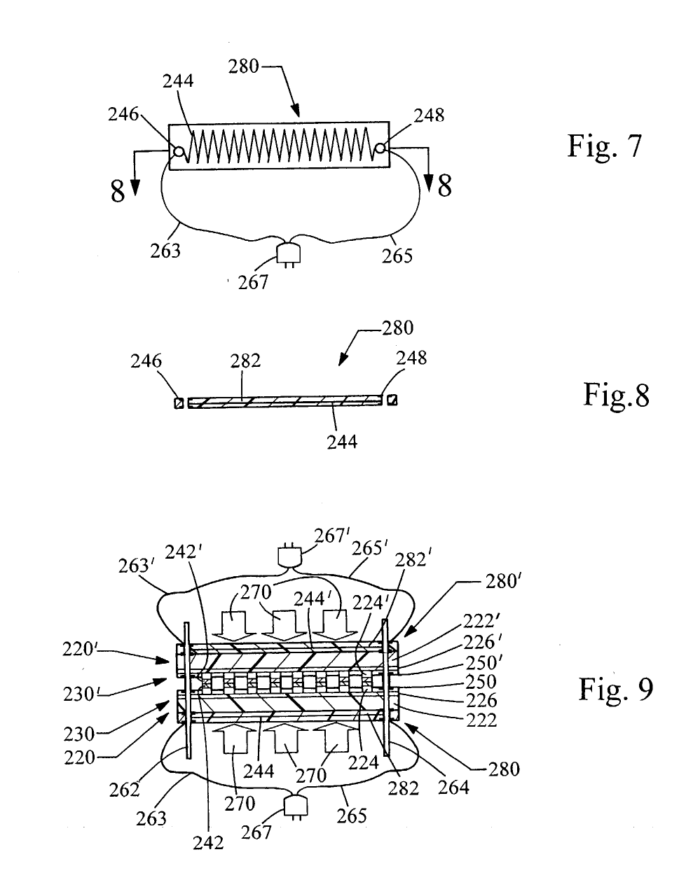

Another embodiment of the invention is shown in FIGS. 7-9. In this embodiment, the heating element has been removed from the substrate of the flatwire and is provided in a separate and external form. As shown in FIGS. 7 and 8, the heating element 244 is again a resistive wire formed into a zig-zagging path. However, the wire has been molded into a heating patch 280 comprising a film 282 having the heating element 244 embedded therein. Similar to the previous embodiment, conductive sleeves 246, 248 are formed into the heating patch and provide an electrical connection to the heating element 244. As shown in FIG. 7, wires 263 and 265 may be connected to the sleeves 246, 248. The wires 263, 265 are connected to an electric power connector 267 for connection to a power source (not shown). Preferably, the film layer 282 is a thermal resistant film, and is preferably constructed of a polymer such as polyimide.

As shown in FIG. 9, two flatwire segments 220, 220′, preferably of identical construction, are positioned adjacent each other such that their respective upgrade sites 230, 230′ are positioned in alignment with one another. That is, preferably the conductors 224, 224′ are aligned and their solder elements 242, 242′ are in engagement. Alignment pins 262, 264 are positioned through the alignment holes formed by conductive sleeves 246, 246′, 248, 248′, which in turn correspond with sleeves formed in the upgrade sites 230, 230′. When the heating elements 244, 244′ are energized, the heating patches 280, 280′ provide heat through the substrates 222, 222′, adhesive layer 226, 226′ to the conductive elements 224, 224′ and their respective solder elements 242, 242′. Again, a holding force indicated by arrows 270 can be utilized to control the flow of substrates 222, 222′, as well as facilitate the interconnection formed by the solder elements 242, 242′. When completed, the alignment pins 262, 264 may be removed, as well as the heating patches 280, 280′ leaving the two flatwire segments 220, 220′ electrically connected via their upgrade sites 230, 230′, which again will be sealed by adhesive layers 250, 250′ similar to those (50, 50′) previously discussed.

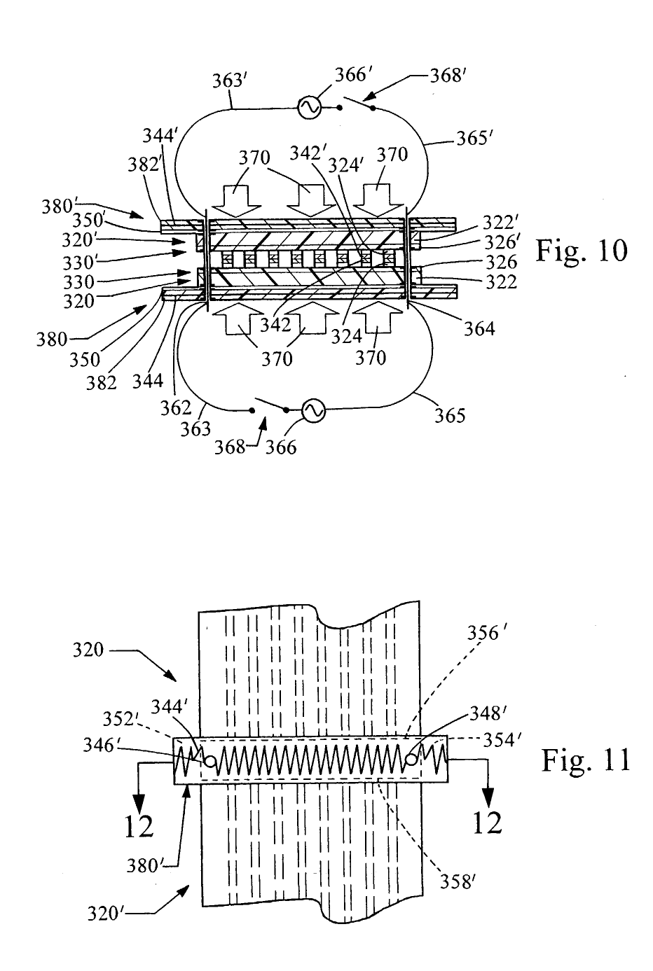

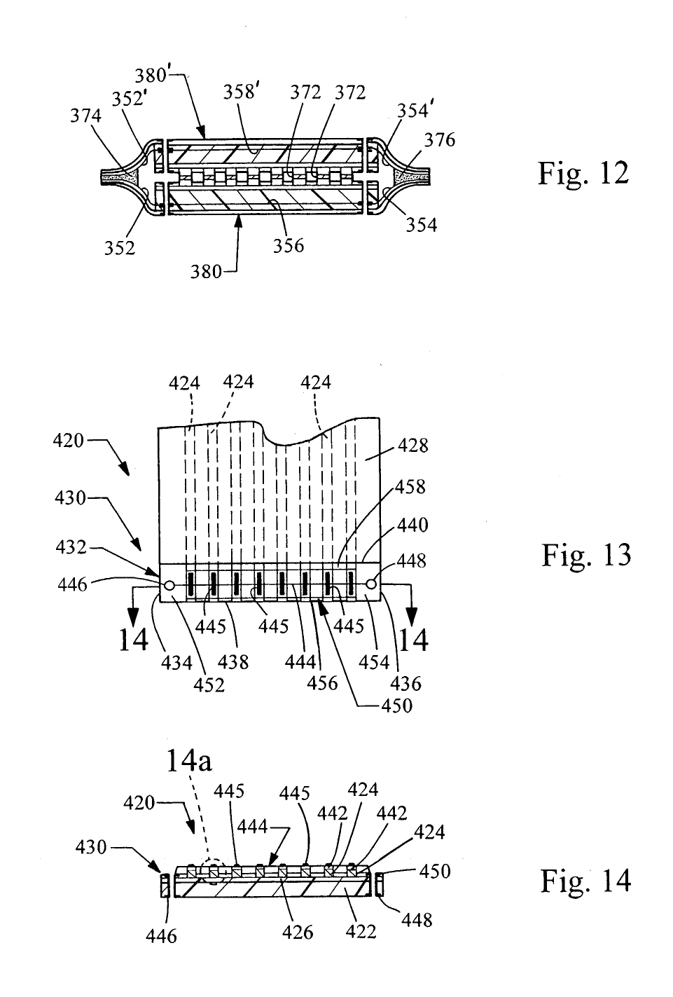

Yet another embodiment of the invention is depicted in FIGS. 10-12. This embodiment is substantially identical to the previous embodiment employing the heating patches 280, 280′. However, the heating patches 380, 380′ are larger and extend beyond the side edges of the upgrade sites 330, 330′. Further, the adhesive layers 350, 350′ have been removed from the flatwire segments 320, 320′ themselves, and have been placed on the inner surfaces of the heating patches 380, 380′. As best seen in FIG. 11, the adhesive layers 350, 350′ include side strips 352′, 354′ and front strip 356′ and rear strip 358′. Accordingly, the portions of the heating elements 380, 380′ extending beyond the flatwire segments 320, 320′ can be sealed using the side strips 352, 352′ and 354, 354′ of the adhesive layers 350, 350′. Further, the front strips 356, 356′ and rear strips 358, 358′ of adhesive seal the front and rear edges of the upgrade sites 330, 330′ from the environment. In this embodiment, it can be seen that the heating patches 380, 380′ become a permanent part of the upgraded flatwire circuit.

A final embodiment is shown with reference to FIGS. 13-15. As in prior embodiments, a flatwire segment 420 includes an upgrade site 430 generally defined by a lateral strip 432 of a masking layer 428 being removed to define side edges 434, 436 and front and rear edges 438, 440. The substrate 422 has a plurality of conductive elements 424 positioned thereon and extending therealong, which are connected by an adhesive layer 426. And again, the conductive elements 424 each include a solder element 442 on their exposed surface in the upgrade site 430. An adhesive layer 450 also extends along the substrate 422 and the connecting adhesive layer 426, and is generally defined by side segments 452, 454 and front and rear segments 456, 458.

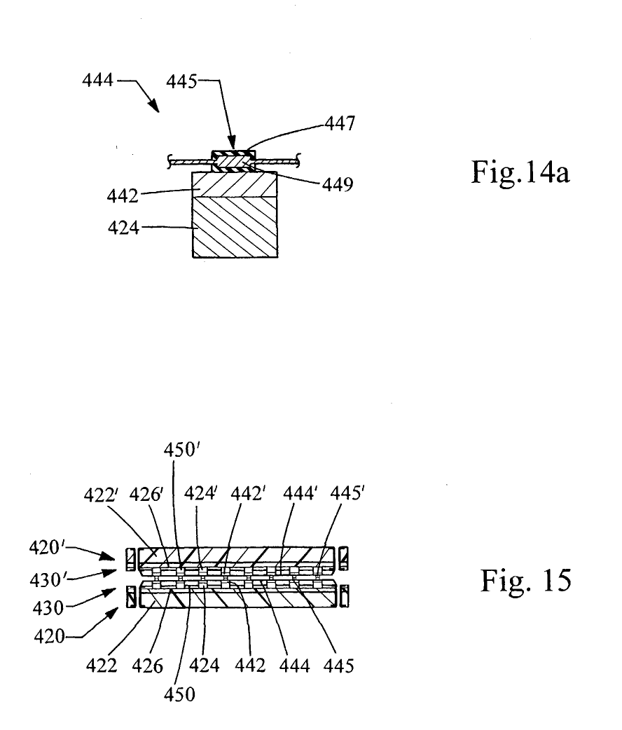

Unlike the prior embodiments, the heating element 444 of this embodiment is incorporated directly onto the conductors 424, and more particularly the solder elements 442, as best seen in FIG. 14. Generally, the heating element 444 includes a resistive wire extending laterally along the upgrade site 430. The heating element or wire 444 further defines individual heating sites 445 where the wire is formed into a zig-zag or other shape to generate high resistance and form a heating site 445. Opposing ends of the heating element 444 are connected to sleeves 446, 448 similar to the previous embodiments, whereby the heating element 444 is provided with current from a power source.

As best seen in the exploded view of FIG. 14a, the heating element 444 includes a heating site 445 comprising a formed wire 449 which can include an insulating coating 447. The heating site 445 is located directly on the solder element 442 positioned above the conductive element 424. It will be recognized that the heating element 444 and more particularly the heating site 445 may be formed directly into and embedded into the solder element 444. Further, it will be recognized that the heating element 444, and more particularly the wire 449 does not need to be insulated by coating 447, and may be readily exposed.

As shown in FIG. 15, two flatwire segments 420, 420′ are positioned relative to one another such that their upgrade sites 430, 430′ are aligned. More particularly, the conductive elements 424, 424′ are aligned, as are the solder elements 442, 442′ as well as the heating elements 444, 444′ each having their individual heating sites 445, 445′. Alignment pins may be used in the heating elements 444, 444′0 are energized to melt the solder elements 442, 442′, thereby creating an interconnect between the conductive elements 424, 424′. It will also be recognized that only one heating element could be utilized on the upgrade sites, so long as the other upgrade site had its conductive elements properly positioned relative to the solder elements.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An upgrade site formed into a flatwire for upgrade or repair of the flatwire, the upgrade site comprising:
a substrate constructed of a flexible polymer;
a plurality of conductive elements positioned on and extending along the substrate;
a solder element positioned on an exposed surface of each conductive element;
a heating element positioned adjacent the substrate and the plurality of conductive elements for heating the solder elements; and
an adhesive layer positioned on the substrate for sealing the upgrade site after upgrade or repair of the flatwire.

2. The upgrade site of claim 1, wherein the adhesive layer is located at opposing side edges of the substrate.

3. The upgrade site of claim 2, wherein the adhesive layer extends laterally between the side edges of the substrate.

4. The upgrade site of claim 2, wherein the adhesive layer extends between the plurality of conductive elements.

5. The upgrade site of claim 1, wherein the adhesive layer is formed of a thermally cured adhesive.

6. The upgrade site of claim 5, wherein the thermally cured adhesive is cured from heat produced by the heating element.

7. The upgrade site of claim 1, wherein the adhesive layer is formed of a pressure sensitive adhesive.

8. The upgrade site of claim 1, wherein a compressive force is applied to an outer surface of the substrate to control the plastic flow of the substrate when the heating element is energized.

9. The upgrade site of claim 8, wherein the adhesive layer is formed of a pressure sensitive adhesive, and wherein the compressive force seals the adhesive layer.

10. The upgrade site of claim 1, wherein the heating element is positioned on an outer surface of the substrate for transmitting heat through the substrate to the plurality of conductive elements and solder elements.

11. The upgrade site of claim 10, wherein the heating element is formed within a polymer film to form a heating patch selectively positionable on the outer surface of the substrate.

12. The upgrade site of claim 11, wherein the adhesive layer is located on the heating patch.

13. The upgrade site of claim 1, wherein the heating element is integrally formed within the substrate for transmitting heat to the plurality of conductive elements and solder elements.

14. The upgrade site of claim 1, wherein the heating element is positioned directly on the solder elements for transmitting heat directly to the solder elements.

15. The upgrade site of claim 1, wherein the substrate includes opposing first and second surfaces, the plurality of conductive elements being positioned on the first surface, and the adhesive layer being positioned on the first surface.

16. The upgrade site of claim 1, wherein the plurality of conductive elements are adhesively attached to the substrate.

17. The upgrade site of claim 16, further comprising a second adhesive layer connecting the substrate and the plurality of conductive elements, the adhesive layer positioned on and extending along the second adhesive layer.

18. A flatwire comprising:
a substrate constructed of a flexible polymer;
a plurality of conductive elements positioned on and extending along the substrate;
a masking layer constructed of a flexible polymer, the masking layer extending along the substrate and covering the plurality of conductive elements; and
the masking layer defining a lateral strip exposing a surface of each conductive elements to form an upgrade site for upgrading or repairing the flatwire, the upgrade site comprising
a solder element positioned on the exposed surface of each conductive element,
a heating element positioned adjacent the substrate and the plurality of conductive elements for heating the solder elements, and
an adhesive layer positioned on the substrate for sealing the upgrade site after upgrade or repair of the flatwire.

19. The flatwire of claim 18, wherein the lateral strip extends from a first side edge to a second side edge of the flatwire.

20. The flatwire of claim 18, wherein the lateral strip defines a front edge, a rear edge, and two opposing side edges of the upgrade site.

21. The flatwire of claim 20, wherein the adhesive layer is located adjacent the opposing side edges of the upgrade site.

22. The flatwire of claim 20, wherein the adhesive layer extends between the side edges and along one of the front edge and the rear edge of the upgrade site.

23. The flatwire of claim 18, wherein the upgrade site includes two positioning holes defined by two conductive sleeves extending through the upgrade site, the conductive sleeves being electrically connected to the heating element.

24. The flatwire of claim 23, wherein the heating element is supplied with electrical current by two alignment pins fit within the two positioning holes.
